(19) United States
(12) Patent Application Publication
(10) Pub. No.: US 2024/0002292 A1
(43) Pub. Date: Jan. 4, 2024

(54) Cement-Based Mixtures

(71) Applicant: C&J Well Services, LLC., Bakersfield, CA (US)

(72) Inventor: Sterling J. Renshaw, Fort Worth, TX (US)

(21) Appl. No.: 18/140,022

(22) Filed: Apr. 27, 2023

Related U.S. Application Data
(60) Provisional application No. 63/335,976, filed on Apr. 28, 2022.

(51) Int. Cl. C04B 20/00; C04B 28/02; C04B 14/08; C04B 20/02; C04B 18/20

(52) U.S. Cl. CPC C04B 20/0004; C04B 28/02; C04B 14/08; C04B 20/026; C04B 18/20; C04B 2111/00637

(57) ABSTRACT

Cement-based mixtures including particles of glass-reinforced plastic are disclosed. In some cases, the mixtures may include particles of glass-reinforced plastic having an average diameter less than approximately 100 microns and/or at least 95% particles of the glass-reinforced plastic in a mixture may have a diameter less than approximately 100 microns. The mixtures may be a dry cement mixture, a cement slurry, or a solidified piece of cement. In some cases, the mixtures may be used to form a solidified oil-field cement plug disposed in and filling a wellbore. A method of making a cement-based mixture includes reducing one or more glass-reinforced plastic components of a used, expired, or defective product into granular particles and blending the granular particles with a prefabricated cement powder or a cement paste to form a substantially homogenous mixture having less than approximately 50% of the granular particles by volume.

### PRIORITY CLAIM

The present application claims priority to U.S. Provisional Patent Application No. 63/335,976 filed Apr. 28, 2022.

### BACKGROUND OF THE INVENTION

### 1. Field of the Invention

This invention generally relates to cement-based mixtures and methods for making such.

### 2. Description of the Related Art

The following descriptions and examples are not admitted to be prior art by virtue of their inclusion within this section.

In-ground wells are used for a variety of reasons, including the extraction of a natural resource such as ground water, brine, natural gas, or petroleum, the injection of a fluid to a subsurface reservoir, or subsurface evaluations. All wells eventually reach the end of their useful life and, thus, are no longer used. To prevent safety hazards as well as soil, air, and groundwater contamination, abandoned wells must be properly plugged with oil-field cement. Such a process, however, can be expensive, particularly if the well is deep and/or wide. Contributing further to costs and concerns, the cement used to form the oil-field cement must be properly formulated such that the formed oil-field cement is of sufficient strength and minimal permeability to insure no leaks, cracks, or gaps develop in the plugged well for many years.

Therefore, it would be advantageous to develop cement-based mixtures and methods for making such which are cheaper, stronger, less permeable and/or environmentally friendlier than conventional mixtures, particularly for but not limited to plugging abandoned oil field wells.

### SUMMARY OF THE INVENTION

Cement-based mixtures including particles of glass-reinforced plastic and methods for making such are disclosed. The following description of various embodiments of mixtures and methods is not to be construed in any way as limiting the subject matter of the appended claims.

An embodiment of a mixture is a dry mixture comprising prefabricated cement powder and particles of glass-reinforced plastic having an average diameter less than approximately 100 microns. A concentration of the particles of glass-reinforced plastic in the dry mixture is greater than approximately 5% by weight of the prefabricated cement powder and at least some of the particles of glass-reinforced plastic comprise a polymer material of the glass-reinforced plastic.

Another embodiment of a mixture includes cement paste and particles of glass-reinforced plastic, wherein at least 95% of particles of the glass-reinforced plastic in the mixture have a diameter less than approximately 100 microns, and wherein at least some of the particles of glass-reinforced plastic comprise a polymer material of the glass-reinforced plastic.

Yet another embodiment of a mixture is a solidified oil-field cement plug disposed in and filling a wellbore, wherein the solidified oil-field cement plug comprises particles of glass-reinforced plastic having an average diameter less than approximately 100 microns, and wherein at least some of the particles of glass-reinforced plastic comprise a polymer material of the glass-reinforced plastic.

An embodiment of a method of making a cement-based mixture includes reducing one or more glass-reinforced plastic components of a used, expired, or defective product into particles having an average diameter less than approximately 100 microns and blending the particles with a prefabricated cement powder or a cement paste to form a substantially homogenous mixture having less than approximately 50% of the particles by volume.

### BRIEF DESCRIPTION OF THE DRAWINGS

Other objects and advantages of the invention will become apparent upon reading the following detailed description and upon reference to the accompanying drawings in which:

FIG. 1 illustrates a flowchart of an example method for making a cement-based mixture having particles of glass-reinforced plastic.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Cement-based mixtures including particles of glass-reinforced plastic and methods for making such are disclosed. The mixtures may include any type of cement, but in some cases may specifically include Portland cement due to its compressive strength. In some cases, the cement may be a cement specifically formulated for use in an in-ground well, including any of those of Classes A through H and, in some cases, may specifically include Classes A, C or G cement due to their makeup being particularly suitable for oil well use (i.e., for oil well cementing or oil well plugging and abandonment). The term “oil-field cement” as used herein refers to a cement mixture poured into or intended to be poured into an oil well. Depending on the amount of water it contains, oil-field cement may be a liquid, a semi-liquid or a solidified form. Regardless of the application to which the cement-based mixtures disclosed herein are used, the particles of glass-reinforced plastic in the cement mixtures may include any type of glass-reinforced plastic material, but in some cases may specifically include E-glass type of glass fibers since E-glass type of glass fibers is commonly used for components of wind turbines and watercraft. As discussed in more detail below, the source of glass-reinforced plastic material for the cement-based mixtures disclosed herein may, in some cases, be from used, expired, or defective fiberglass products, such as but not limited to components of wind turbines and watercraft. Regardless of the types of cement and glass-reinforced plastic particles used, the cement-based mixtures disclosed herein may, in some cases, include other substances, such as but not limited to fly ash, ground slag, silica flour, limestone, clay, bauxite, iron ore, shells, chalk, marl, shale, slag, slate, plaster, aggregates (e.g., sand, stone, gravel) and/or water.

The term “glass-reinforced plastic” as used herein refers to a composite material made of a plastic matrix reinforced with glass fibers. The plastic matrix may be a thermoset polymer matrix or a thermoplastic. The composite material is often alternatively referred to in the materials science industry as “glass-fiber reinforced plastic”, “fiberglass-reinforced plastic” or “fiberglass”, each of which may be used herein interchangeably with the term “glass-reinforced plastic”. It is noted that the term “fiberglass” is also used in the materials science industry to refer to glass fibers themselves (i.e., without being incorporated into a matrix), but the term as used herein refers to the composite material of a plastic matrix reinforced with glass fibers. Accordingly, the phrase “particles of glass-reinforced plastic” as used herein refers to pieces of glass fiber from a glass-reinforced plastic material, pieces of plastic matrix from a glass-reinforced plastic material, and/or pieces of a compound of glass fiber and plastic matrix together from a glass-reinforced plastic material. The latter two of such particle categories are referenced herein as “particles of glass-reinforced plastic comprising a polymer material of the glass-reinforced plastic”.

In some cases, the particles of glass-reinforced plastic of the cement-based mixtures disclosed herein may be of a size comparable to the size of the particles of prefabricated cement powder used to formulate the cement-based mixtures (i.e., on the same order of magnitude). For example, the particles of glass-reinforced plastic of the cement-based mixtures disclosed herein may, in some embodiments, have an average diameter which is on the same order of magnitude as the particles of prefabricated cement powder used to formulate the cement-based mixtures. In addition or alternatively, the particles of glass-reinforced plastic may, in some embodiments, have a particle size distribution range within the particle size distribution range of the particles of prefabricated cement powder or vice versa. In some embodiments, it may be advantageous for the particles of glass-reinforced plastic to have a smaller average diameter than the particles of prefabricated cement powder used to formulate the cement-based mixtures such that the particles of glass-reinforced plastic may fill in voids between the particles of cement, possibly decreasing the permeability of an article formed from the cement-based mixture. In other cases, the particles of glass-reinforced plastic may have a larger average diameter or an average diameter approximately equal to the average diameter of the particles of prefabricated cement powder used to formulate the cement-based mixtures. In any case, it may, in some embodiments, be advantageous for a cement-based mixture disclosed herein to have a concentration of particles of glass-reinforced plastic less than approximately 50% by volume of the mixture. In additionally or alternatively, and in cases in which the cement-based mixture is a dry mixture, it may be advantageous for the concentration of prefabricated cement powder to be more than approximately 50% by volume of the dry mixture.

In any case, the particles of glass-reinforced plastic in the cement-based mixtures disclosed herein may, in some embodiments, have an average diameter less than approximately 100 microns, or more specifically, an average diameter less than approximately 50 microns, less than approximately 20 microns, less than approximately 10 microns, less than approximately 5 microns, less than approximately 3 microns, or less than approximately 1 micron. In addition or alternatively, the particles of glass-reinforced plastic in the cement-based mixtures disclosed herein may, in some embodiments, have a particle size distribution in which at least 95% of the particles have a diameter less than approximately 100 microns, or more specifically, an average diameter less than approximately 50 microns, less than approximately 20 microns, less than approximately 10 microns, less than approximately 5 microns, less than approximately 3 microns, or less than approximately 1 micron.

In some cases, the cement-based mixtures disclosed herein may have a particle size distribution in which at least 95% of the particles have a diameter between approximately 0.1 microns and approximately 100 microns, or more specifically, an average diameter between approximately 0.1 microns and approximately 50 microns, between approximately 0.1 microns and approximately 20 microns, between approximately 0.1 microns and approximately 10 microns, between approximately 0.1 microns and approximately 5 microns, between approximately 0.1 microns and approximately 3 microns, or between approximately 0.1 microns and approximately 1 micron. In some cases, the cement-based mixtures disclosed herein may be void particles of glass-reinforced plastic having a diameter greater than approximately 1.0 millimeter. Such a maximum diameter may be particularly applicable for oil-field cement mixtures, since large aggregate is typically not included in such mixtures.

In general, the particles of glass-reinforced plastic considered for the cement-based mixtures disclosed herein may be spherical, non-spherical or irregular in shape. It is noted that the reference of particle diameters discussed above and throughout the disclosure provided herein apply to spherical particles, but may also apply to non-spherical particles and particles which are irregular in shape if one of the following equations is used to determine their diameters:
Volume-based particle size:

$$D = \sqrt[2]{3 V / 4 π} \qquad Eq . ( 1 )$$

where D=diameter of representative sphere
   V=volume of particle
Area-based article size:

$$D = \sqrt[2]{4 A / π} \qquad Eq . ( 2 )$$

where D=diameter of representative sphere
   A=surface area of particle
Weight-based particle size:

$$D = 2 \sqrt[3]{3 W / 4 π d g} \qquad Eq . ( 3 )$$

where D=diameter of representative sphere
   W=weight of particle
   d=density of particle
   g=gravitational constant

In some cases, the cement-based mixtures disclosed herein may be a heterogeneous mixture comprising cement and particles of glass-reinforced plastic. In other embodiments, the cement-based mixtures disclosed herein may be a substantially homogeneous mixture comprising cement and particles of glass-reinforced plastic. As used herein, the term “substantially homogeneous mixture” refers to a mixture having component distributions that vary by less than 5% across the mixture. Alternatively stated, if you take random samples from different parts of a “substantially homogeneous mixture”, the concentration of components in those samples will vary by less than 5% relative to each other. A method of making the substantially homogeneous mixture will generally include blending the cement, the particles of glass-reinforced plastic, and any other additional component/s in a manner (on a piece of equipment) sufficient to produce a substantially homogeneous mixture.

Regardless of whether the cement-based mixtures disclosed herein are heterogeneous or substantially homogeneous, the cement-based mixtures disclosed herein may in the form of a dry powder, a cement slurry, a solidified form of cement, concrete (liquid, semi-liquid or solid), mortar, stucco, grout, or thin-set adhesive. Alternatively stated, particles of glass-reinforced plastic may be included in a dry powder form of a cement-based mixture (i.e., prior to adding water to the mixture to form a cement slurry) and/or they may be added upon making a cement slurry. The term “cement-based dry powder” as used herein refers to a dry mixture of prefabricated cement powder and other dry substances, including but not limited to particles of glass-reinforced plastic, used to form a cementitious article. The term “cement slurry” as used herein refers to a fluid (i.e., liquid or semiliquid) mixture of prefabricated cement powder, water, and other substances, including but not limited to particles of glass-reinforced plastic, used to form a cementitious article. Upon the water reacting with the prefabricated cement powder and possibly the other substances (a process known in the industry as “hydration”), the cement slurry gradually forms a solidified form of cement. The fluid mixture throughout this hydration process (i.e., from the initial blending of the prefabricated cement powder, water, and one or more other substances until the mixture is solidified) is referenced herein as a “cement slurry” despite the change of matter and the reaction taking place.

The reaction during a hydration process of a cement slurry forms a cement paste binder, which serves to bind filler substances in the slurry which do not participate in the reaction. The term “cement paste” as used herein differs from the term “cement slurry” in that the term “cement paste” refers to the binder component of a cement slurry or solidified cement form. More specifically, the term “cement paste” as used herein refers to the binder component of the liquid, semi-liquid or solid cement-based mixtures disclosed herein, particularly a binder formed from the combination of prefabricated cement powder and water and possibly supplemental cementitious materials or pozzolanic substances. In view thereof, the liquid, semi-liquid or solidified cement-based mixtures disclosed herein (i.e., the cement-based mixtures disclosed herein other than in a dry powder form) may be referenced as including a cement paste and particles of glass-reinforced plastic and optionally other “filler” substances which do not chemically react to form part of the cement paste binder.

A benefit of including particles of glass-reinforced plastic in the cement-based mixtures disclosed herein is that at least a portion of the particles may serve as a pozzolanic material. In particular, it is contemplated that due to their high concentration of silica, some or all of the glass fibers in some or all of the particles of glass-reinforced plastic may react with byproducts of the cement hydration process to form additional calcium silicate hydrate, improving the physical characteristics of a resulting cementitious article. As a result, particles of glass-reinforced plastic in a resulting cementitious article may include smaller pieces of glass fibers or no glass fibers as compared to the concentration of glass fiber pieces included in the initial particles of glass-reinforced plastic used to make the cement-based mixture. The polymer material of the glass-reinforced plastic, however, is not expected to react much if at all in a cement slurry and, thus, the liquid, semi-liquid or solidified cement-based mixtures disclosed herein may be referenced as including a cement paste and particles of glass-reinforced plastic comprising a polymer material of the glass-reinforced plastic. It is noted that some of the glass fibers in some or all of the particles of glass-reinforced plastic may not react in a cement slurry and, thus, the liquid, semi-liquid or solidified cement-based mixtures disclosed herein may additionally include particles of glass fibers and/or particles having both glass fiber and the polymer of the glass-reinforced plastic.

In any case, the reaction of glass fiber particles from the particles of glass-reinforced plastic in the cement-based mixtures disclosed herein may, in some embodiments, reduce the size of the particles of glass-reinforced plastic in the cement slurry or resulting solid cementitious article. As such, in some embodiments, the cement slurries and/or solidified cement articles disclosed herein may include particles of glass-reinforced plastic having an average diameter less than the original particles of glass-reinforce plastic used to form the cement slurries and/or solidified cement articles.

In some embodiments, the cement-based mixtures disclosed herein may only include cement (i.e., either prefabricated cement powder or a cement paste) and particles of glass-reinforced plastic. In other cases, the cement-based mixtures disclosed herein may consist essentially of cement and particles of glass-reinforced plastic, meaning that the mixture may include additional substances but not in sufficient concentration to substantially affect the physical characteristics of an article formed from the cement-based mixture. In yet other embodiments, the cement-based mixtures disclosed herein may include other substances (i.e., in addition to cement and particles of glass-reinforced plastic) in sufficient concentration to affect the physical characteristics of an article formed from the cement-based mixture. Examples of substances which may be used to affect the physical characteristics of an article formed from the cement-based mixture include but are not limited to fly ash, ground slag, silica flour, limestone, clay, bauxite, iron ore, shells, chalk, marl, shale, slag and/or slate.

It is contemplated that the inclusion of particles of glass-reinforced plastic in the cement-based mixtures disclosed herein may serve as a partial or whole substitute for one or more of such substances in conventional cement-based mixtures. For example, silica flour is often added to cement slurries for wellbore cementing to increase the compressive strength of the cement matrix and reduce the permeability of a resulting solidified oil-field cement formation. It is contemplated that particles of glass-reinforced plastic may serve to provide a similar source of silica and, consequently, may provide either or both of such benefits and potentially better than silica flour. Thus, it is contemplated that particles of glass-reinforced plastic may be used as a partial or whole replacement of silica flour in conventional cement-based mixtures.

In light of such contemplations, the cement-based mixtures disclosed herein may, in some embodiments, be void of silica flour. In other cases, the cement-based mixtures disclosed herein may include silica flour, but less than what is used in conventional cement slurries. For instance, conventional cement slurries, particularly for oil-field cements, having silica flour generally include 35%-45% silica flour by weight of cement. The cement-based mixtures disclosed herein, however, may be a cement slurry having less than approximately 30% silica flour by weight of cement and, in specific embodiments, less than approximately 15% of silica flour by weight of cement or less than approximately 5% of silica flour by weight of cement. In yet other cases, the cement-based mixtures disclosed herein may include silica flour in a concentration similar to conventional cement slurries, i.e., include 35%-45% silica flour by weight of cement, and in some cases, it may be advantageous to do so. In particular, it was discovered during the development of the cement-based mixtures disclosed herein that a cement slurry having particles of glass-reinforced plastic and a concentration of silica flour between 35%-45% by weight of cement exhibited better compressive strength than cement slurries having particles of glass-reinforced plastic, but a lower concentration of silica flour or no silica flour.

In any case (i.e., regardless of whether silica flour is included), the cement-based mixtures disclosed herein may, in some cases, have a concentration of particles of glass-reinforced plastic between approximately 0.1% by weight of cement and approximately 40% by weight of cement and, in specific embodiments, between approximately 5% by weight of cement and approximately 35% by weight of cement or between approximately 10% by weight of cement and approximately 30% by weight of cement. In some cases, it may be advantageous to have a concentration of particles of glass-reinforced plastic greater than approximately 5% by weight of the cement. In particular, such a minimum concentration threshold was shown during the development of the cement-based mixtures disclosed herein to contribute to a compressive strength level desired for oil-field cements. Conversely, the cement-based mixtures disclosed herein may, in some cases, have a concentration of particles of glass-reinforced plastic less than approximately 35% by weight of cement. In particular, it was found during the development of the cement slurries disclosed herein that paddles of mixing equipment often gum up when a cement-based mixture having a concentration of particles of glass-reinforced plastic greater than approximately 35% by weight of cement is used, impeding the slurry to be mixed thoroughly and causing excessive time to clean the equipment for future use. It is noted, however, if use of a cement-based mixture having a concentration of particles of glass-reinforced plastic greater than approximately 35% by weight of the cement is desired, it is contemplated that a supplemental solvent could be investigated for the making the slurry, particularly to avoid the formation of such gums.

In general, methods for making the cement-based mixtures disclosed herein include mixing cement with particles of glass-reinforced plastic. In some cases, the mixing process may include dry blending prefabricated cement powder with the particles of glass-reinforced plastic (i.e., blending prefabricated cement powder and particles of glass-reinforced plastic together without the addition of a liquid). Such a process may form a heterogeneous or a substantially homogeneous mixture. In other embodiments, the mixing process may include mixing prefabricated cement powder with water to form a cement slurry and mixing the particles of glass-reinforced plastic with the cement slurry (i.e., mixing the particles of glass-reinforced plastic at the same time as the prefabricated cement powder is mixed with water or mixing the particles of glass-reinforced plastic after the prefabricated cement powder is mixed with water). In any of such scenarios (i.e., the dry blending process or fluidic blending process of forming a cement slurry), the mixing process may include mixing one or more substances (such as but not limited to fly ash, ground slag, silica flour, limestone, clay, bauxite, iron ore, shells, chalk, marl, shale, slag and/or slate) into the mixture, particularly, prior to, during or subsequent to mixing the cement (i.e., the prefabricated cement powder or the cement slurry) with the particles of glass-reinforced plastic.

As noted above, the source of fiberglass material for the cement-based mixtures disclosed herein may, in some cases, be from products comprising glass-reinforced plastic or may be remnants of glass-reinforced plastic material from manufacturing products comprising glass-reinforced plastic. In specific cases, the source of glass-reinforced plastic material for the cement-based mixtures disclosed herein may be from used, expired, or defective products comprising glass-reinforced plastic. In particular, used, expired, or defective products comprising glass-reinforced plastic may offer a cost effective and/or environmentally conscientious source of glass-reinforced plastic for the cement-based mixtures disclosed herein. To date, there are many products comprising glass-reinforced plastic (such as but not limited to windmill components (particularly turbine blades), watercraft, bathtubs, and automotive parts), but recycling the glass-reinforced plastic material from such products is very limited and, thus, used, expired, or defective products comprising glass-reinforced plastic are being disposed of in landfills.

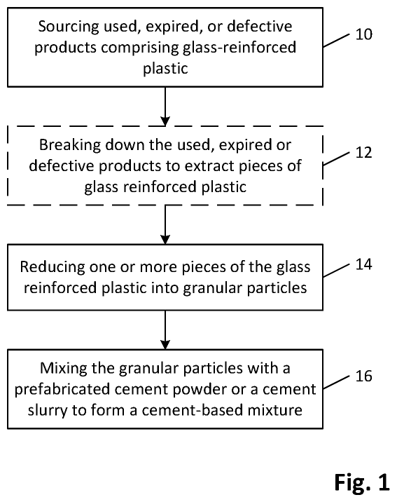

FIG. 1 illustrates a flowchart of an example process for forming cement-based mixtures from used, expired, or defective products comprising glass-reinforced plastic. As respectively shown in blocks 10 and 12 of FIG. 1, methods for making the cement-based mixtures disclosed from used, expired, or defective products comprising glass-reinforced plastic may include sourcing the used, expired, or defective products and, if needed (as denoted by the dotted line outlining block 12), breaking them down to extract pieces of glass-reinforced plastic. Subsequent thereto, the method includes reducing one or more of the pieces of glass-reinforced plastic into granular particles as denoted in block 14. The reducing process of block 14 may involve crushing, grinding, milling and/or any other manner for disintegrating glass-reinforce plastic. In any case, the method further includes obtaining cement, particularly a prefabricated cement powder or cement slurry, and then mixing the cement with the granular particles of glass-reinforced plastic to form a cement-based mixture as denoted in block 16 of FIG. 1.

The term “granular”, as used herein, refers to fragments having a diameter between approximately 0.1 micron and approximately 1 centimeter. Coordinating with the discussion provided above for the cement-based mixtures described herein, the reducing step of block 14 may, in some embodiments, include reducing one or more of the pieces of glass-reinforced plastic into particles having a diameter less than approximately 100 microns, or more specifically, into particles an average diameter less than approximately 50 microns, less than approximately 20 microns, less than approximately 10 microns, less than approximately 5 microns, less than approximately 3 microns, or less than approximately 1 micron. In addition or alternatively, the reducing step of block 14 may, in some embodiments, include reducing one or more of the pieces of glass-reinforced plastic into particles having a particle size distribution in which at least 95% of the particles have a diameter less than approximately 100 microns, or more specifically, an average diameter less than approximately 50 microns, less than approximately 20 microns, less than approximately 10 microns, less than approximately 5 microns, less than approximately 3 microns, or less than approximately 1 micron. Other characteristics of the cement-based mixture formed by the method outlined in FIG. 1 may include any of the characteristics described for the cement-based mixtures disclosed herein, including but not limited to the type and concentration of the cement in the mixture, the type and concentration of the particles of glass-reinforced plastic in the mixture, the option to include substances other than cement and particles of glass-reinforced plastic, whether the mixture is heterogeneous or substantially homogeneous.

As noted above, the cement-based mixtures and methods disclosed herein may be particularly suitable for plugging an abandoned oilfield well. As a result, solidified oil-field cement plugs which are disposed in and fill wellbores may be made having any of the composition and/or size of particles of glass-reinforced plastic disclosed herein. The concentration of particles of glass-reinforced plastic in the solidified oil-field plug may be between approximately 0.1% by weight of the plug and approximately 40% by weight of the plug and, in specific embodiments, between approximately 2% by weight of cement and approximately 35% by weight of the plug or between approximately 5% by weight of the plug and approximately 30% by weight of the plug. Other characteristics of the plug may include any of the characteristics described for the cement-based mixtures disclosed herein, including but not limited to the type and concentration of the cement in the plug, the type, size, and concentration of the particles of glass-reinforced plastic in the plug, the option to include substances other than cement and particles of glass-reinforced plastic, and whether the plug is heterogeneous or substantially homogeneous.

Preliminary tests of compressive strength of cement slurries having particles of glass-reinforced plastic as compared to conventional oil-field cement slurries having 35% silica flour without particles of glass-reinforced plastic were conducted during the development of the cement-based mixtures disclosed herein. The specifics regarding the tests are shown in Table 1 below, with Blend 1 denoting a conventional oil-field cement slurry having 35% silica flour by weight of cement without particles of glass-reinforced plastic (GRP), Blend 2 denoting a cement slurry having approximately 3% of particles of glass-reinforced plastic by weight of cement without any silica flour, Blend 3 denoting a cement slurry having 20% of particles of glass-reinforced plastic by weight of cement without any silica flour, and Blend 4 denoting a cement slurry having approximately 3% of particles of glass-reinforced plastic by weight of cement and 35% silica flour by weight of cement. The cement in each of the blends was Class G cement and the density and mixability of each of the blends was 15.60 ppg and 5, respectively. The compressive strength tests were conducted at a temperature of 130° F. and a pressure of 3000 psi. Table 1 shows the time each of the blends took to achieve a compressive strength of 50 psi, 500 psi, and 1000 psi.

TABLE 1

| | Blend 1 | | | Blend 4 |
|---|---|---|---|---|
| | 35% bwoc | Blend 2 | Blend 3 | 35% bwoc |
| Compressive | silica | no silica | no silica | silica |
| Strength | flour, | flour, ~3% | flour, 20% | flour, ~3% |
| (psi) | no GRP | bwoc GRP | bwoc GRP | bwoc GRP |
| 50 | 02:49 hr:min | 01:48 hr:min | 01:53 hr:min | 01:44 hr:min |
| 500 | 07:20 hr:min | 03:45 hr:min | 03:36 hr:min | 02:55 hr:min |
| 1000 | 10:23 hr:min | 06:11 hr:min | 06:01 hr:min | 04:16 hr:min |

As shown by the test results in Table 1, Blends 2-4 resulted in significantly faster time to achieve the noted compressive strengths of 50 psi, 500 psi, and 1000 psi, indicating the solidified cement of Blends 2-4 having better compressive strength as compared to a solidified cement of Blend 1. In particular, Blends 2 and 3 having no silica flour reached key pressure points 33%-51% faster than Blend 1, indicating Blends 2 and 3 to have better compressive strength than Blend 1 by approximately the same percentage. Another interesting discovery is Blend 4 (the blend having a combination of particles of glass-reinforced plastic and silica flour) exhibited better compressive strength than each of Blends 1-3. It is noted that Blends 2-4 of the cement slurries used for the tests denoted below were formed from particles of glass-reinforced plastic sourced from used products, particularly expired wind turbines. It is expected that cement slurries having particles of glass-reinforced plastic sourced from other used fiberglass products or newly formed fiberglass will exhibit similar increases in compressive strength relative to cement slurries including silica flour without particles of gas s-reinforced plastic.

It will be appreciated to those skilled in the art having the benefit of this disclosure that this invention is believed to provide cement-based mixtures and methods for making such. Further modifications and alternative embodiments of various aspects of the invention will be apparent to those skilled in the art in view of this description. For example, although the disclosure emphasizes cement-based mixtures for plugging wellbores, the scope of their use is not necessarily so limited. In particular, the cement-based mixtures disclosed herein may be considered for applications other than wellbore plugging, including wellbore completion tasks or any other cement application including those which are not affiliated with wellbores. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims. The term “approximately” as used herein refers to variations of up to +/−5% of the stated number.

What is claimed is:

1. A dry mixture, comprising:
prefabricated cement powder; and
particles of glass-reinforced plastic having an average diameter less than approximately 100 microns, wherein a concentration of the particles of glass-reinforced plastic in the dry mixture is greater than approximately 5% by weight of the prefabricated cement powder, and wherein at least some of the particles of glass-reinforced plastic comprise a polymer material of the glass-reinforced plastic.

2. The dry mixture of claim 1, wherein the concentration of the particles of glass-reinforced plastic in the mixture is less than approximately 35% by weight of the prefabricated cement powder.

3. The dry mixture of claim 1, wherein the particles of glass-reinforced plastic have an average diameter less than approximately 20 microns.

4. The dry mixture of claim 1, wherein the particles of glass-reinforced plastic have an average diameter less than approximately 5 microns.

5. The dry mixture of claim 1, wherein the dry mixture is void of silica flour.

6. The dry mixture of claim 1, further comprising silica flour.

7. A mixture comprising:
cement paste; and
particles of glass-reinforced plastic, wherein at least 95% of particles of the glass-reinforced plastic in the mixture have a diameter less than approximately 100 microns, and wherein at least some of the particles of glass-reinforced plastic comprise a polymer material of the glass-reinforced plastic.

8. The mixture of claim 7, wherein at least 95% of particles of glass-reinforced plastic in the mixture have a diameter less than approximately 50 microns.

9. The mixture of claim 7, wherein at least 95% of particles of glass-reinforced plastic in the mixture have a diameter less than approximately 20 microns.

10. The mixture of claim 7, wherein the mixture is a cement slurry.

11. The mixture of claim 7, wherein the mixture is solidified cement.

12. The mixture of claim 11, wherein the solidified cement is solidified oil-field cement.

13. The mixture of claim 7, wherein the mixture is concrete, mortar, stucco, grout or a thin-set adhesive.

14. A method of making a cement-based mixture, comprising:
reducing one or more glass-reinforced plastic components of a used, expired, or defective product into granular particles having an average diameter less than approximately 100 microns; and
blending the granular particles with a prefabricated cement powder or a cement paste to form a substantially homogenous mixture having less than approximately 50% of the granular particles by volume.

15. The method of claim 14, wherein the one or more components of used, expired, or defective products comprise windmill components.

16. The method of claim 14, wherein the one or more components of used, expired, or defective products comprise watercraft components.

17. The method of claim 14, further comprising blending silica flour with the prefabricated cement powder or the cement paste prior to, during, or subsequent to blending the particles with the prefabricated cement powder or the cement paste.

18. A solidified oil-field cement plug disposed in and filling a wellbore, wherein the solidified oil-field cement plug comprises particles of glass-reinforced plastic having an average diameter less than approximately 100 microns, and wherein at least some of the particles of glass-reinforced plastic comprise a polymer material of the glass-reinforced plastic.

19. The solidified oil-field cement plug of claim 18, wherein a concentration of the particles of glass-reinforced plastic in the solidified oil-field cement plug is greater than approximately 2% by weight.

20. The solidified oil-field cement plug of claim 18, wherein the particles of glass-reinforced plastic have an average diameter less than approximately 10 microns.
